(19) United States
(12) Patent Application Publication
(10) Pub. No.: US 2012/0260424 A1
(43) Pub. Date: Oct. 18, 2012

(54) FITTED BED SHEET

(76) Inventor: Arun Agarwall, Dallas, TX (US)

(21) Appl. No.: 13/448,958

(22) Filed: Apr. 17, 2012

Related U.S. Application Data
(60) Provisional application No. 61/476,510, filed on Apr. 18, 2011.
(60) Provisional application No. 61/535,182, filed on Sep. 15, 2011.

(51) Int. Cl. A47G 9/04; B31B 1/00

(52) U.S. Cl. 5/497; 493/393

(57) ABSTRACT

A bedding product such as a sheet may include a top panel, wherein a perimeter of the top panel is defined by an elastic-type binding material. At least one extension panel may be secured to at least a portion of the perimeter of the top panel. In turn, at least one side panel may be secured to at least one of the perimeter of the top panel and at least one extension panel, wherein the side panel extends downwardly with respect to the perimeter. The top panel may be generally arcuate such as having a generally elliptical shape before being fitted over a mattress.

### CROSS-REFERENCE TO RELATED APPLICATIONS

This application claims the benefit of U.S. Provisional Application Nos. 61/476,510, filed Apr. 18, 2011, and 61/535,182, filed on Sep. 15, 2011 the disclosures of which are hereby incorporated by reference in their entirety.

### FIELD

The present disclosure relates to a bedding product and more particularly to a fitted bed sheet.

### BACKGROUND

Beds are known to have a wide range of different thickness mattresses even for a particular sized bed. While fitted bed sheets are known they have had difficult in maintaining the fit of the sheet with respect to the mattress during use. Thus, it would be desirable to have an enhanced fitted bed sheet that improves upon the deficiencies of prior designs.

### BRIEF DESCRIPTION OF THE DRAWINGS

FIG. 1 is an exemplary fitted sheet.

FIG. 2 is a top view of the exemplary fitted sheet illustrated in FIG. 1 prior to formation of the sheet.

FIG. 3 is a method of forming the exemplary fitted sheet.

FIG. 4 is a perspective view of a corner region of the exemplary fitted sheet in an installed orientation about a mattress.

### DETAILED DESCRIPTION

Referring now to the discussion that follows and also to the drawings, illustrative approaches are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

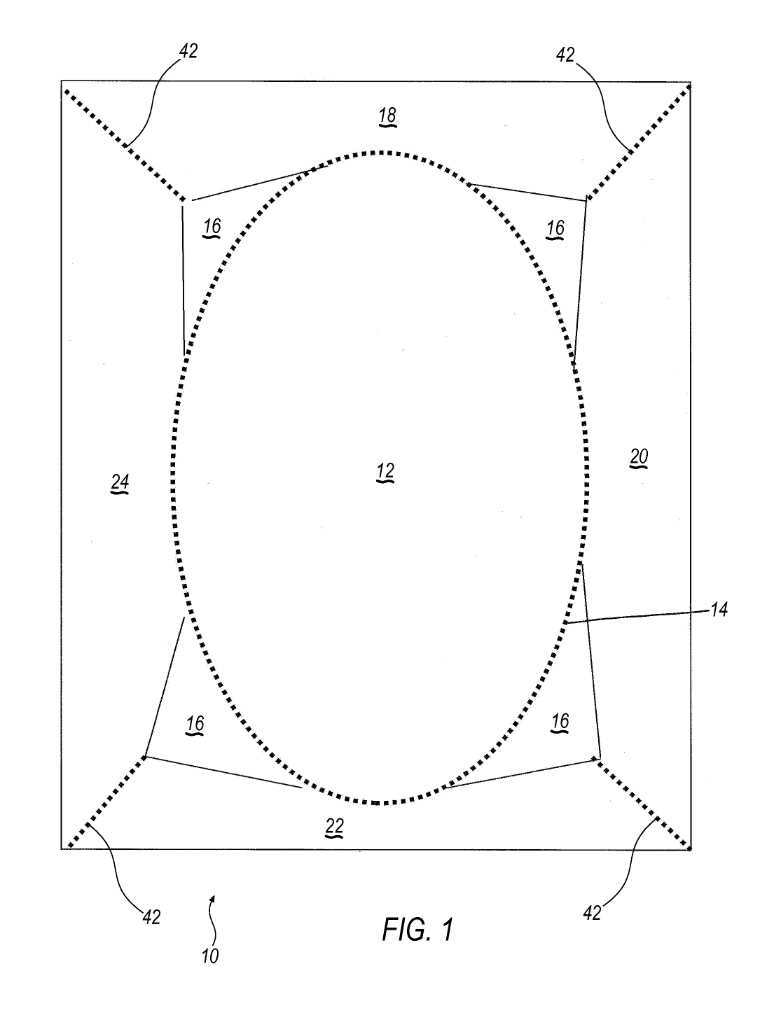

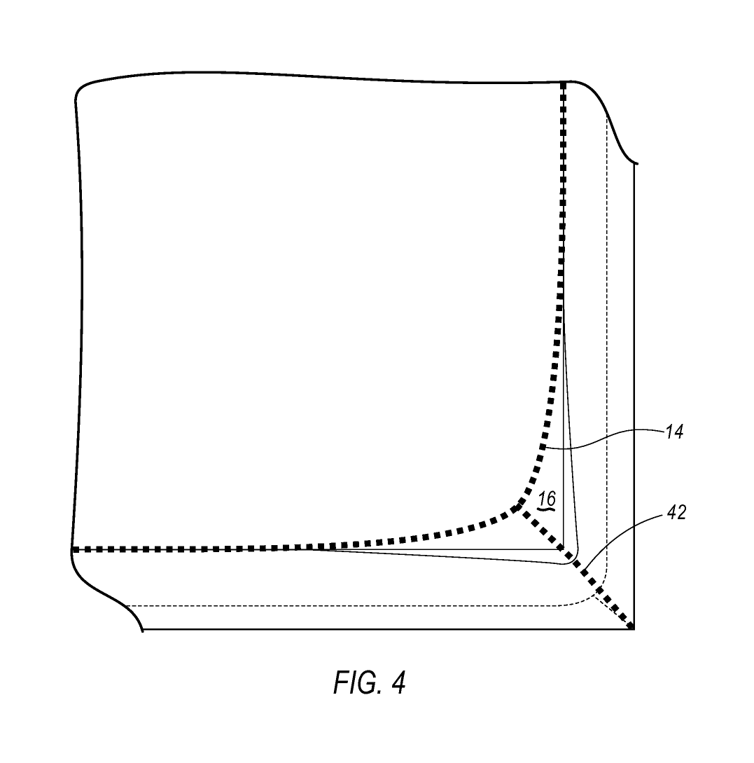

FIG. 1 illustrates an exemplary fitted sheet 10 configured to conform to the contours of a mattress and capable of maintaining the fit of the sheet with respect to the mattress during use. To facilitate illustration of the sheet 10 with respect to a top panel, an elastic type material is not shown along the edges of the side panels in the figure, but may be included as discussed in more detail below and as shown with respect to FIG. 4. The fitted sheet 10 may take many different forms and include multiple and/or alternate components. While an exemplary fitted sheet is shown in FIG. 1, the exemplary components illustrated in the figure are not intended to be limiting. Indeed, additional or alternative components and/or implementations may be used.

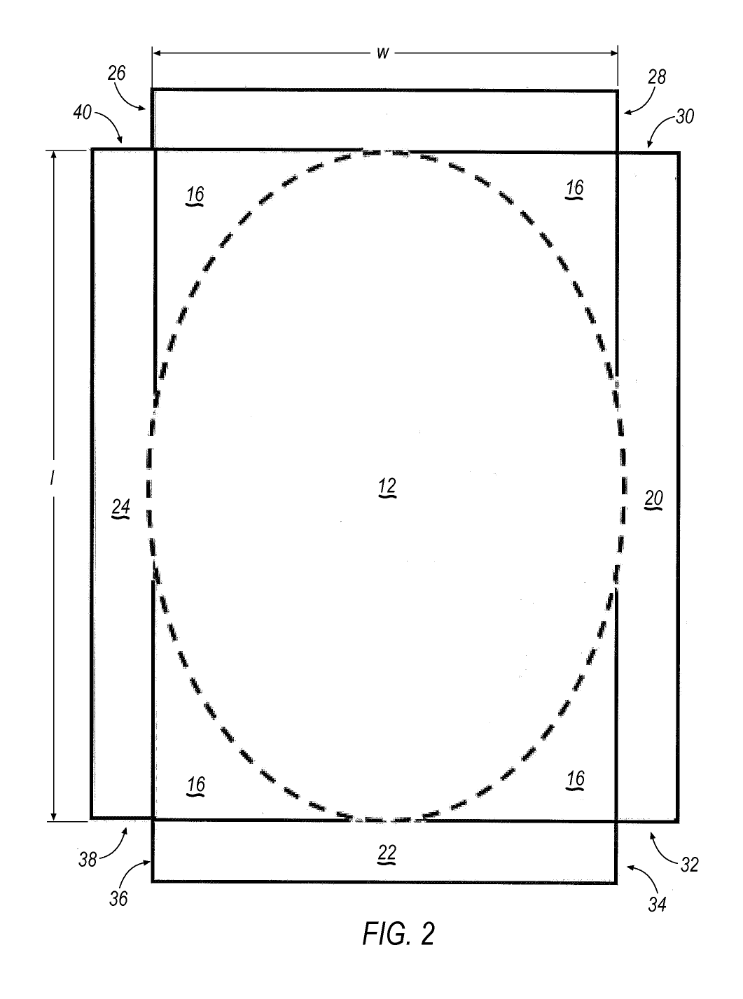

FIG. 2 illustrates a top view of the exemplary fitted sheet 10 illustrated in FIG. 1 at an intermediate stage of manufacture. FIG. 1 is at a later stage of manufacture, but is not finalized if there is an interest in having an elastic-type material along the edges of the side panels as illustrated in FIG. 4.

The fitted sheet 10 may include a top panel 12. As illustrated, the top panel 12 is arcuate and being generally elliptical in shape. However, any other suitable shape may be used to form the top panel. For example, the top panel 12 may be generally circular or generally hexagonal. The top panel 12 may be formed from any suitable type of material including, but not limited to, cotton, silk, rayon or any combination thereof.

The top panel 12 is further defined by a perimeter 14. The perimeter 14 of the top panel includes a binding. The binding may be formed of any suitable elastic-type material including LYCRA®, spandex yarn, cotton yarn, a LYCRA® infused cotton weave, or any combination thereof. This further includes the use of other materials such as an elastic “rubber” band component that is encased within perimeter 14. This is true for all of the seams and perimeters of the sheet 10. The elastic-type binding may be applied to the perimeter 14 of the top panel 12 using any suitable means including sewing, gluing, a five thread stitching technique, and by binding it to the perimeter 14 using a 504 overlock stitch with a binding attachment. The five thread stitching technique uses multiple threads that are overlocked with each other to provide strength and flexibility to the area where the stitches are made. In one exemplary approach, the elastic-type material binding is secured to the edge of the perimeter 14.

The exemplary fitted sheet 10 further includes a plurality of extension panels 16. The extension panels 16 may be generally triangular in shape, such that when attached to the top panel 12, the top panel 12 is deformed to become a significantly less elliptical shape when fitted over the mating mattress (e.g., somewhat generally rectangular in shape), but biased to desire to return to its original undeformed shape. However, the extension panels 16 may take on any variety of shape depending on the size, style, and/or design of the mattress for which the sheet is being created. Indeed, in other exemplary fitted sheets, the extension panels 16 may be generally rectangular in shape. The extension panels 16 may be formed from any suitable type of material including, but not limited to, cotton, silk, rayon or any combination thereof. In some approaches extension panels may include any suitable elastic-type material including LYCRA® fabric, spandex yarn, cotton yarn, a LYCRA® infused cotton weave, or any combination thereof.

As illustrated in FIGS. 1 and 2, the top panel 12 and the plurality of extension panels 16 may be formed from separate materials joined together using any suitable method. In one approach, the extension panels 16 may be attached to the top panel 12 using the elastic-type binding material that is secured to the perimeter 14 of the top panel 12. However, other suitable methods may include sewing and gluing the plurality of extension panels 16 to the top panel 12. The top panel 12 and the extension panels 16 may be formed from the same material or different types of material depending on the sheet design.

Moreover, while top panel 12 is shown in an elliptical or oval shape in both FIGS. 1 and 2, as a practical matter, it does not have to have this shape before the elastic-type binding material is secured to the perimeter 14 of the top panel 12. In some approaches it may even be generally rectangular in nature. However, once the binding material is secured the oval shape shown in FIG. 1 may be adopted and the binding material may be applied in a manner to result in this shape. Moreover, while extension panels 16 are shown in FIG. 2 as secured to top panel 12 before the elastic-type binding material is secured about perimeter 14, they may be secured before, while or even after the binding material is secured.

In some approaches, the same binding mechanism used to secure the elastic-type binding material (e.g., stitches of thread through overlapping portions of perimeter 14 that form a sleeve to retain the binding material may also be used to retain a corresponding edge of extension panels 16. Alternatively, a different binding mechanism (e.g., different stitches of material or an adhesive) may be utilized.

The exemplary fitted sheet 10 further includes a plurality of side panels, including a first side panel 18, a second side panel 20, a third side panel 22, and a fourth side panel 24. The plurality of side panels 18, 20, 22, 24 may be formed from any suitable material including, but not limited to, cotton, silk, rayon or any combination thereof. As illustrated, the plurality of side panels 18, 20, 22, 24 extend downwardly from at least a portion of the perimeter 14 defining the top panel 12 and from the plurality of extension members 16. The side panels 18, 20, 22, 24 may be configured to extend downwardly the thickness of a mattress. However, the side panels 18, 20, 22, 24 may also be configured to extend downwardly the thickness of the mattress and underneath the mattress. A bottom edge of one or more of the side panels 18, 20, 22, 24 may also include an elastic-type material binding configured to assist in maintaining the sheet in its fitted position. Once again, the same or different binding mechanism used to help retain extension panels 16 may be used with respect to panels 18, 20, 22, and 24. As illustrated, an edge of each of these panels is adjacent to and may abut periphery 14 at select locations.

In the illustrated approach, opposing side panels 18, 22 extend along a first extent “w” representing a width dimension of the mattress while two opposing side panels 20, 24 extend along a second extent “l” representing a length dimension of the mattress. Generally, the first side panel 18 and the third side panel 22 are substantially congruent and the second side panel 20 and the fourth side panel 24 are substantially congruent. However, the dimensions of the opposing side panels may take on various sizes based on mattress design and contours.

As illustrated in FIG. 2, the first side panel 18 is defined by a first end 26 and a second end 28. Similarly, the second side panel 20 is defined by a first end 30 and a second end 32, the third side panel 22 by a first end 34 and a second end 36, and the fourth side panel 24 by a first end 38 and a second end 40. When the sheet is folded to form the fitted sheet 10 illustrated in FIG. 1, described in further detail below, the first end and second end of each adjacent side panel may be mated together. The first end and second end of adjacent side panels may be secured together using the same elastic-type binding material described above with respect to the perimeter 14. That is, the binding may be formed of any suitable elastic-type material including LYCRA®, spandex yarn, cotton yarn, a LYCRA® infused cotton weave, or any combination thereof. The elastic-type binding may be applied using any suitable means including the first end and second end of adjacent side panels may be secured together with the elastic-type binding material using a 301 plain lock stitch with a binding attachment, sewing, gluing and the five thread stitching technique.

The use of the elastic-type binding around the perimeter 14 of the top panel 12 and to secure the adjacent side panels allows the sheet to conform to the shape of the mattress and better maintain the position of the sheet on the mattress when in use. That is, the elastic-type binding allows for more stretchability in the top panel 12 and in the corners of the fitted sheet 10. Thus, the fitted sheet 10 is capable of stretching and conforming to mattresses of varying depths. Therefore, the same fitted sheet 10 may conform to mattresses ranging from standard sizes to premium pillow top sizes. The shape of panels 12, 16, 18, 20, 22, and 24 shall be affected by the nature of their securement to mating components and affected by how the resulting sheet is secured to a bed mattress.

Moreover, the use of the elastic-type binding also creates a better fit, in that, the elastic nature of the binding secures the fitted sheet 10 to the mattress creating less wrinkles The fitted sheet 10 may also be easier to apply and remove from the mattress and may be easier to fold and store during nonuse (e.g., it may be more compact).

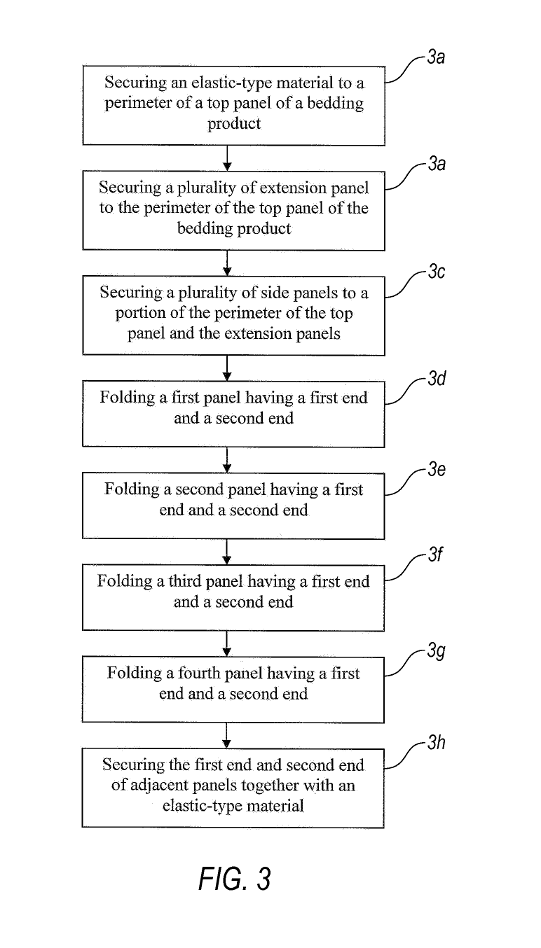

An exemplary approach to forming the fitted sheet 10 is illustrated in FIG. 3. Accordingly, the top panel 12, extension panels 16, and the side panels 18, 20, 22, 24 may be configured to be folded into fitted sheet 10, as illustrated in FIG. 1.

As illustrated in block 3a, an elastic-type binding is secured to the perimeter 14 of the top panel 12. The plurality of extension panels 16 may be secured to the perimeter 14 of the top panel 12. The plurality of extension panels 16 may be secured simultaneously or the extension panels may be secured individually using any suitable technique. The plurality of side panels 18, 20, 22, 24 may also be secured to at least a portion of the perimeter 14 of the top panel 12 and the extension panels 16.

Once the top panel 12, extension panels 16, and the side panels 18, 20, 22, 24 are secured, the plurality of side panels 18, 20, 22, 24 may be folded downwardly with respect to the top panel 12 to form the fitted sheet 10. The plurality of side panels may be simultaneously folded downwardly or the side panels may be folded downwardly individually, as illustrated in 3d-3g.

When the first side panel 18 and the second side panel 20 are folded downwardly, the second end 28 of the first panel 18 and the first end 30 of the second side panel 20 abut. Similarly, the second end 32 of the second side panel 20 and the first end 34 of the third side panel 22 abut when the second side panel 20 and the third side panel 24 are folded. The second end 36 of the third side panel 22 and the first end 38 of the fourth side panel 24 also abut when the third side panel 22 and the fourth side panel 24 are folded. Finally, the second end 40 of the fourth side panel 24 abut the first end 26 of the first side panel 18 when the fourth side panel 24 and the first side panel 18 are folded. As illustrated in block 3h, the abutting edges of the first ends and second ends of the adjacent side panels are secured using an elastic-type binding material as represented by seams 42. The elastic-type binding material may be applied using any suitable technique, including the five thread stitching technique discussed above. All of the abutting ends may be secured together simultaneously or the abutting ends may be secured individually forming each corner of the fitted sheet 10 separately.

While it is noted above that top panel 12 may have a variety of shapes, in one approach, as illustrated in FIG. 4, the perimeter 14 is sized such that it is adjacent the edges of a mating mattress (not shown) when fitted over the mattress. When fitted over a mattress the corners, represented in part by extension panels 16 in combination with perimeter 14 represent contributors to a biasing mechanism to keep the corners in contact with and tucked in about the mattress. There is greater biasing in a region associated with the extension panels 16 as compared to a midpoint defined between adjacent extension panels 16. The bottom edges of the side panels 18, 20, 22, and 24 may also be contributors to the biasing mechanism when they include elastic type bindings as illustrated. The biasing mechanism may encompass both a top surface of the mattress and a bottom surface of the mattress as well the thickness of the mattress at the corners as represented by the seams 42 to facilitate a tight retention of the sheet about the mattress with minimal wrinkling Less biasing is required at the midpoints of each side panel 18, 20, 22, 24 generally equally spaced between opposing corners, a feature that may be beneficial when using an elliptical or oval shape as represented in FIG. 1.

Although discussed above with respect to a fitted sheet, this disclosure may pertain to any form of fitted linen configured to conform to the contours of a mattress. This disclosure may also pertain to fitted linens of all sizes, including a 60×80×16 fitted sheet.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

What is claimed is:

1. A bedding product comprising:
a top panel, wherein a perimeter of the top panel is defined by an elastic-type binding material;
at least one extension panel secured to at least a portion of the perimeter of the top panel;
at least one side panel secured to at least one of the perimeter of the top panel and at least one extension panel, wherein the side panel extends downwardly with respect to the perimeter.

2. A sheet comprising a top portion having a base panel comprising a generally arcuate perimeter, at least one extension panel extending outwardly from said perimeter.

3. A sheet as recited in claim 2, wherein four extension panels extend outwardly from said perimeter.

4. A sheet as recited in claim 3, wherein said base panel and said four extension panels form a generally rectangular outer perimeter to said top portion.

5. A sheet as recited in claim 2, wherein said perimeter includes an elastic material.

6. A sheet as recited in claim 2, wherein said generally circular perimeter is generally elliptical and said extension panel is generally triangular.

7. A sheet as recited in 2, wherein said base panel is somewhat rectangular in shape after being fitted about a mating mattress.

8. A sheet as recited in claim 7, wherein there is greater biasing of said perimeter adjacent to an attached extension panel as compared to a midpoint of a corresponding side panel defined between opposing extension panels after being fitted about the mating mattress.

9. A sheet as recited in claim 2, wherein said perimeter comprises only one portion of a biasing mechanism.

10. A sheet as recited in claim 10, wherein at least a subset of (1) a seam defined between adjacent side panels and (2) a bottom edge of said side panels comprising an additional portion of said biasing mechanism.

11. A sheet as recited in claim 10, wherein said extension panels comprise a further portion of said biasing mechanism.

12. A method comprising:
securing an elastic-type material to a perimeter of a top panel of a bedding product;
securing a plurality of extension panes to said perimeter of said top panel of the bedding product;
securing a plurality of side panels to a portion of said perimeter of said top panel and said extension panels;
folding a first panel having a first end and a second end;
folding a second panel having a first end and a second end;
folding a third panel having a first end and a second end;
folding a fourth panel having a first end and a second end; and
securing said first end and said second end of adjacent panels with an elastic-type material, thereby forming a seam.

13. A method as claimed in claim 12, further comprising forming said top panel to have a generally elliptical shape after being secured to said extension panels and said side panels in combination with said perimeter.

14. A method as claimed in claim 13, shaping said top panel and said extension panels to create an overall rectangular outline prior to being fit over a mating mattress.

15. A method as claimed in claim 13, deforming said top panel into a significantly less elliptical shape when fitted over the mating mattress.

16. A method as claimed in claim 15, creating greater biasing in a region associated with said extension panels as compared to a midpoint defined between adjacent extension panels.

17. A method as claimed in claim 16, said biasing including at least said perimeter.

18. A method as claimed in claim 17, said biasing further including said seam defined between adjacent side panels.
